(19) United States
(12) Patent Application Publication
(10) Pub. No.: US 2016/0140292 A1
(43) Pub. Date: May 19, 2016

(54) SYSTEM AND METHOD FOR SORTING A PLURALITY OF DATA RECORDS

(71) Applicant: Khalid Al-Dhubaib, Cleveland, OH (US)

(72) Inventor: Khalid Al-Dhubaib, Cleveland, OH (US)

(21) Appl. No.: 14/944,537

(22) Filed: Nov. 18, 2015

Related U.S. Application Data
(60) Provisional application No. 62/081,208, filed on Nov. 18, 2014.

(51) Int. Cl. G06F 19/00; G06F 17/30

(52) U.S. Cl. CPC G06F 19/32; G06F 17/30595

(57) ABSTRACT

A system and method is provided for sorting a plurality of data records. The method includes the steps of collecting a plurality of data entries from a data record of the plurality of data records. The method further assigns each data entry of the plurality of data entries with a unique entry ID. An initial state of a given data entry of the plurality of data entries is also identified, and a given state is assigned to the given data entry. A change in state of the given data entry is determined from the initial state to the given state. The given data entry is sorted according to a first criteria and a second criteria, with the sorting comprising assigning a score to the given data entry. The given data entry is prioritized based on the score assigned to the given data entry respective of a score assigned to each remaining data entry of the plurality of data entries. An output representing a prioritized list of the plurality of data entries is generated based on a respective score that can be displayed in a display.

### RELATED APPLICATIONS

This application claims priority from U.S. Provisional Application No. 62/081,208, filed Nov. 18, 2014, the subject matter of which is incorporated herein by reference.

### BACKGROUND OF THE INVENTION

Generation of big data has become commonplace with the advent of inexpensive data-gathering mechanisms, and an increasing ability to store large volumes of data. These data sets are extremely large, and oftentimes too complex for traditional data processing applications to handle. As a result, there is an increasing challenge in how to efficiently handle and manipulate big data and extract meaningful information from the big data sets. Organizing these data into useful subsets, particularly in real-time, is difficult using currently existing methods.

Sorting algorithms are a useful asset in organizing data logically. Since sorting methodology plays an important role in the operation of data processing systems, there is great interest in improving existing systems and methods. Methods of utilizing sorting algorithms to sort complex objects faster than previously known systems and methods facilitate the efficient sorting of complex objects.

### SUMMARY OF THE INVENTION

In accordance with an aspect of the present invention, a system and method is provided for sorting a plurality of data records. The method includes the steps of collecting a plurality of data entries from a data record of the plurality of data records. The method further assigns each data entry of the plurality of data entries with a unique entry ID. An initial state of a given data entry of the plurality of data entries is also identified, and a given state is assigned to the given data entry. A change in state of the given data entry is determined from the initial state to the given state. The given data entry is sorted according to a first criteria and a second criteria, with the sorting comprising assigning a score to the given data entry. The given data entry is prioritized based on the score assigned to the given data entry respective of a score assigned to each remaining data entry of the plurality of data entries. An output representing a prioritized list of the plurality of data entries is generated based on a respective score that can be displayed in a display.

In accordance with another aspect of the present invention, the method includes where each data entry is associated with a patient condition or event, and each data entry is assigned an initial state.

In accordance with yet another aspect of the present invention, the initial state of each of the data entries from each of the plurality of data records is different.

### BRIEF DESCRIPTION OF THE DRAWINGS

FIG. 1 is a block diagram of an example computing system configuration for collecting and sorting data in accordance with a data sorting system, and presenting a transformed data output.

FIG. 2 is a block diagram of example components for the computing system of FIG. 1.

FIG. 3 is a flow diagram illustrating example computer executable instructions for a data sorting system.

FIG. 4 is a flow diagram illustrating example computer executable instructions for implementing a data sorting system.

FIGS. 5 and 6 provide examples of a cluster with qualities and properties of a data entry workflow.

### DETAILED DESCRIPTION OF INVENTION

The present invention describes a highly time-efficient method for generating a highly organized data set from general databases. The proposed invention provides a method of efficiently transforming unstructured data into summary information through a series of four steps. With an increase in the generation of big data, processing big data into summary information has become increasingly difficult due to the time and resource limitations of current methodologies. There are different methods that can be used to transform unstructured data into summary information. The efficiency of the method and the time and resources required can vary greatly, which can greatly limit the processing abilities as the size of the input dataset increases.

One method of processing unstructured data is based on sequentially performing a series of steps, wherein obtaining the result of a previous step guides the execution of the next step, and each step is completed before moving on to the next step in the sequence. As the size of the input dataset into this type of method increases, there is an exponentially sharp increase in the time required to execute the steps sequentially, and this method becomes limited by the resources available to execute the steps in a reasonably finite amount of time. Another method is based on performing steps in parallel, wherein the individual steps can be executed independently and simultaneously without requiring input from the completion of a previous step in order to proceed. The parallel step method reduces the resources required to process a dataset and allows near real-time execution of commands, transforming uncategorized data to yield summary information in real-time.

Thus, in accordance with the data sorting system described herein, a method employs parallel steps to rapidly categorize data entries to allow efficient production of a prioritized list of summary information. The method includes one or more steps for identifying a unique classification category and intervention combination (hereafter collectively “combination”) in a database. Thus, two criteria can be selected to describe each data entry. A first criteria can be dynamic, such that a characteristic associated with the first criteria can change over time. The second criteria can correspond to a static characteristic that does not change. Entries from each combination are grouped based on a first criteria, and identified by a state. The change in state is determined relative to each combination in a list of combinations for each data entry, whereby each combination is classified. Subsequently, each combination is grouped and ordered according to the second criteria. Thus, the categorizing process assigns a new identifier called state to each data entry. The state can be used to estimate changes in state over a series of events associated with the data entry, providing a list whereby a user can quickly identify similarities and differences within a body of data, which would not be readily apparent or discoverable from looking at the data in the initial uncategorized format. In view of the foregoing, the present invention relates to a data sorting system and method that organizes large amounts of data in near real-time, the data provided for real-time decision support models or built into a risk ratio and confusion matrix and/or predictive analytics engine. Each data entry can be classified, separating the entities by unique ID, while potentially simultaneously sorting each data entry by one or more criteria. Additionally, by determining and storing the changes between the state of database entries over time, and storing properties of the data entries based on criteria that does not change, the data support system can, in near real-time, produce organized and prioritized data lists, where the most similar entries are arranged closest to one another.

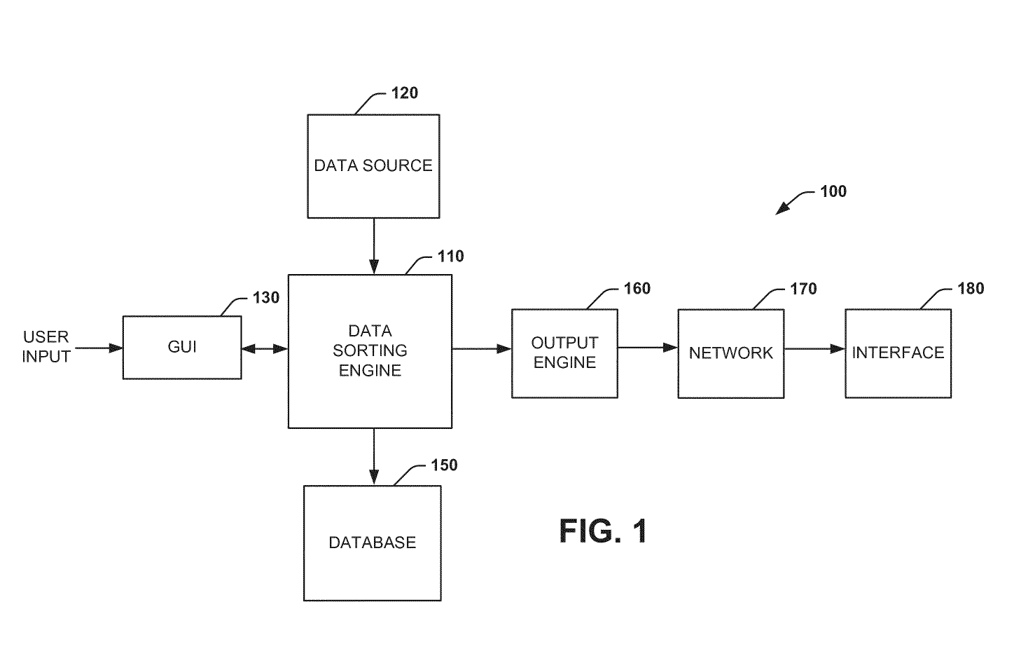

Turning to FIG. 1, an example computing configuration is provided to implement a data sorting system to facilitate decision support. A data sorting engine 110 is provided to perform the steps that transform raw data from a plurality of data records into data representing a significant identifier corresponding to one or more characteristics of one or more events. The resulting data is presented in a hierarchal listing in accordance with a score assigned by the data sorting system based on assignments and sorting of the data entries. In particular, the data sorting engine 110 can accept and analyze data from a variety of data source 120, from a user via a graphical user interface (GUI) 130, and a database 150, for example. The GUI 130 includes a physician/technical portal such that a user can interact with the system 100. Physicians and other healthcare providers (e.g. radiologists, equipment operators, etc.) will use the portal to create orders for tests or procedures for patients. Administrative users will use the portal to generate rules, manage healthcare data, and manage account information for the data sorting system. Typically, administrators will have greater access to the system.

Each source of data is in communication with the data sorting engine 110 over a link to transfer data, such as an electrical or optical cable and a wireless network. Having provided the data pertaining to a particular sorting requirement, the data sorting engine 110 can implement one or more rules to transform the raw data into a representation that can be provided to an output engine 160. For example, each data entry can be assigned a unique identifier (ID), can be assigned a score according to one or more status determinations, compared to other data entries and, based on the comparison, presented in a list that prioritizes data entries by score. The organization of these data entries can be a valuable tool in facilitating decision support.

The output engine 160 can then provide the transformed data to a network 170, through which the transformed data is sent to an interface 180 configured to generate a desired outcome, such as another data structure, a display, or an automated system for further processing. In this way, users can access the results of the output engine 160 through a personal computer, a mobile device (e.g. smart phone, personal digital assistant, etc.), a tablet device, and a laptop. Security systems, such as firewalls can be placed throughout the computing components, including between the network 170 and the output engine 160 and interface 180, to ensure compliance with healthcare privacy rules.

Other computing configurations that allow computer implemented instruction to be run and accessed by one or more users are also applicable to the principles described herein. Non-limiting examples include an SAS model, on premise computing, cloud computing, portable, and stand-alone devices. For example, the healthcare system or software, including the database and rule engine, can reside entirely on a single user device or on multiple, connected devices.

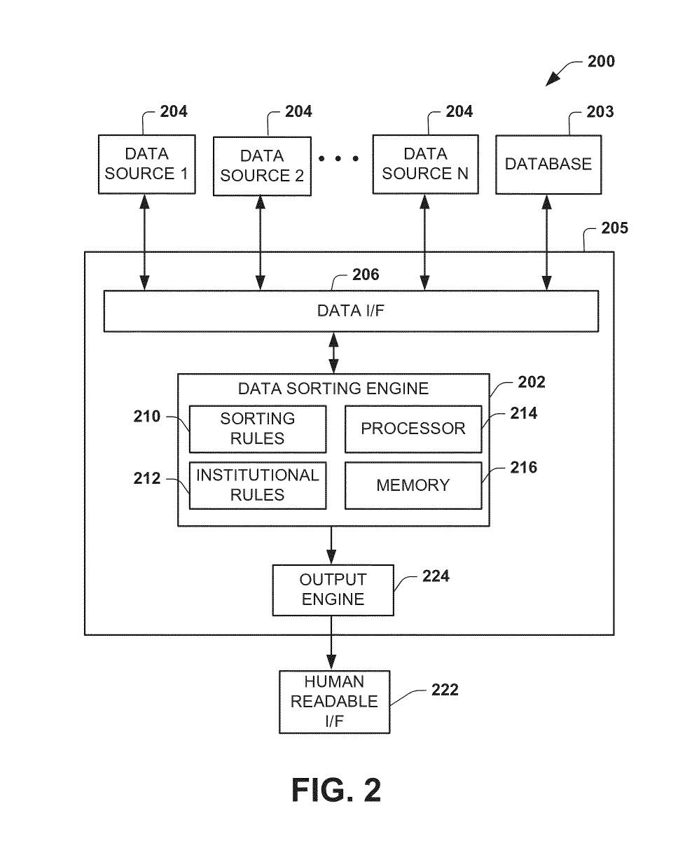

Turning to FIG. 2, an example data sorting system comprising computer implemented instructions and data components for sorting a plurality of data records is provided. The system 200 includes one or more databases 203, such as an electronic health record. A plurality of data sources 204 can represent any device or system that provides data to the system such as, in a non-limiting example, a graphical user interface (GUI) such as GUI 130 of FIG. 1, sensors to collect medical data from a patient, including instruments that measure heart rate, blood pressure, blood oxygen levels, electrocardiographic information, amount of a component in a patient's blood, temperature, etc. The data from the various data sources can be provided to the data sorting system, such that each data source can interact with each other through the system. Specifically, each data source 204 and each database 203 can be connected to a computing platform 205 by a data interface (IF) 206, to transmit and receive information.

The database 203 stores healthcare, user or patient data, and results for laboratory tests. In other words, any data that can be used in performing data sorting can be stored in database 203. For example, user or patient data includes administrator data, site or institution data, physician data, and patient data. Such data comprises names, identifications, passwords, contact information, background information, notices, etc., useful in tracking patient care and facilitating decision support. Each patient can be associated with a given physician and/or facility.

The data sorting engine 202 can include a processor 214 for executing computer readable instructions. A memory 216 can store information, such as data pertaining to executing such computer readable instructions, as well as other required data. Rules and instructions pertaining to data sorting can be added, manipulated and stored in a sorting rules 210 section. Sorting rules 210 can include a plurality of criteria to classify, group, and/or sort the data entries or combinations of those data entries. Further, institutional rules 212 can provide rules associated with a particular institution or regulatory body from where the rules originate. As such, the healthcare data, and data sorting engine 202 can be customized to suit the preferences or needs of different users (e.g. a hospital, a healthcare jurisdiction, a set of patients belonging to a certain group, e.g. of a health insurance plan). The data from the data sources 204 and database 203 can then be used by the data sorting engine 202 to generate lists with prioritized data entries. Following performance of the data sorting system, the results are provided to an output engine 224 for presentation to a user. For example, the output engine 224 can provide the results to an interface 222, such as a computer storage medium, connected servers or a personal computer, a mobile device, a tablet, laptop, or any other device for presenting information or further analyzing the data.

The example data components described herein relate to general healthcare, although they can be adapted for specific healthcare fields, including non-healthcare implementations, while keeping to the principles described herein. As an example, a patient with diabetes would visit the hospital regularly to have their A1C levels in the blood monitored, update dosage levels on any prescriptions, visit a nutrition counselor, perhaps receive smoking cessation help if they are a smoker, and so on. Data collected during every visit would include blood pressure, temperature, weight, height, pulse, blood oxygen levels through a pulse oximeter, thorough blood panel (including RBC, WBC, iron, and A1C levels), a list of medications, any complaints from the patient, and notes from the nurses and doctors.

Rules created or amended by a user can include data from the specific patient to generate a specific set of parameters or provide a specific outcome relating to healthcare decisions for the patient and the particular condition. Rules can be associated with a specific type of desired outcome (e.g., lab results for a particular patient) or can be generated for a tailored response (e.g., number of emergency room visits by a particular patient in out-of-network facilities). A user and/or administrator can create and/or modify the rules by providing credentials to the response score decision support system via a graphical user interface (GUI) to facilitate interaction with the system. By associating rule information with a particular scenario, a rule is formed. The rule expressions can include combinations of healthcare data and logic operators (e.g. greater than, equal to, less than, within the range, Boolean comparators, etc.).

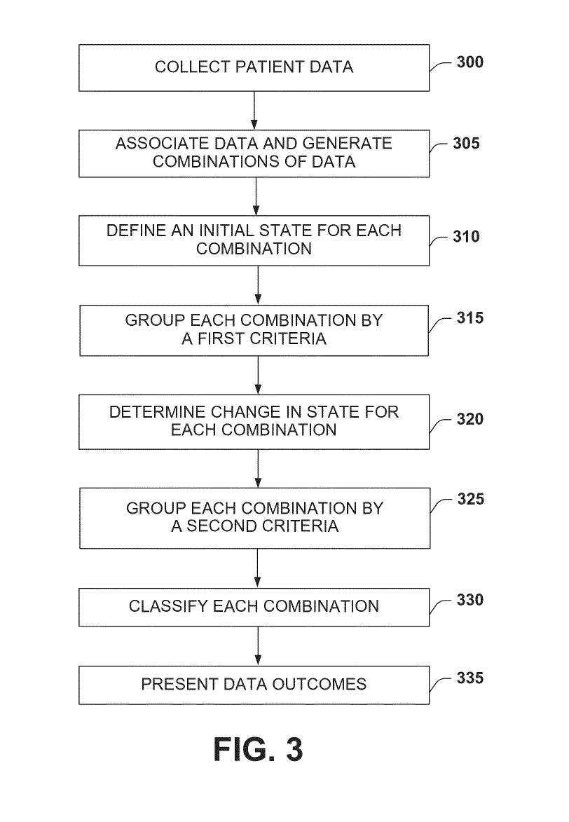

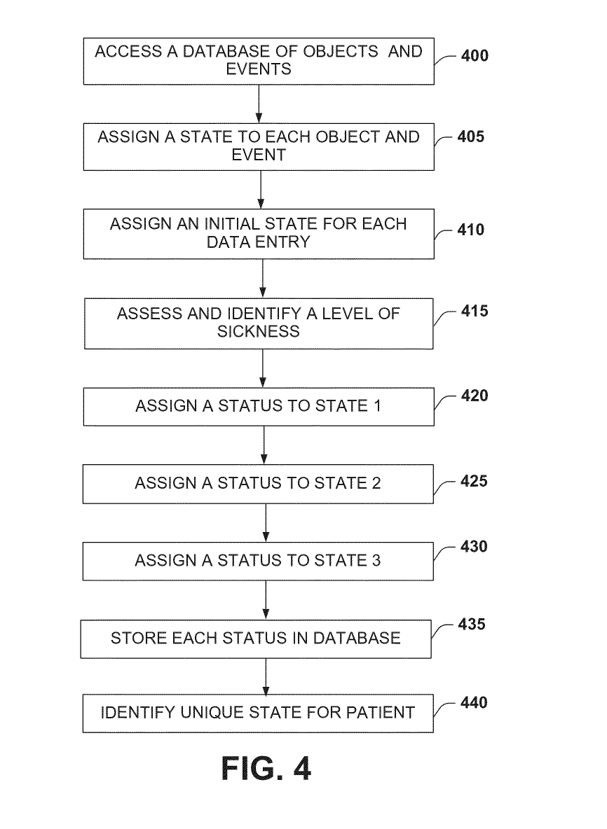

In view of the forgoing structural features corresponding to a data sorting system, an example method is illustrated in FIG. 3. In step 300 data associated with the patient with a unique classification category is collected for manipulation in the data sorting system, such as the system described in FIGS. 1 and 2. In step 305, the collected data entries are associated with an intervention to create combinations containing both the unique classification category and an intervention that are associated with a corresponding initial data set. In step 310, an initial state of each combination is identified. Two criteria are selected for each data entry to describe the entries, where the first, dynamic criteria can change over time and the second criteria can be static. As an example, an event, element, or object for each data entry associated with each combination can be assigned in the aggregate. An example assignment flow diagram is provided in FIG. 4, below.

In step 315 the individual data entries from each combination are grouped and sorted based on a first criteria. Additionally or alternatively, the selected combination can be subject to one or more of the rules. Moreover, data entries associated with individual patients could be sorted by various data identifiers, for example, the date they visited the hospital, allowing the user to group all the visits of a single patient together. Supposing a patient had visited the hospital ten different times, step 315 could sort the visits by the date of each of the ten visits, and list them together as corresponding to the same patient. Thus, the date of those visits would each be a data entry that can be manipulated by the rules.

In step 320 a change in state for each data entry is determined (e.g., estimated) relative to each combination in a list of combinations for each data entry associated therewith. For any data entry that experiences at least two or more events (i.e. a change in state), step 320 allows the change in state to be determined between two sequential events. As an example, for a diabetic patient that visits the hospital on at least three separate occasions, each visit is assigned an associated state. For example, from visit 1 to visit 2, there was a change in state (state 1 to state 2). From visit 2 to visit 3, a second change in state (state 2 to state 3) was identified. Using the example of the patient, step 320 allows the user (e.g., physician) to determine changes in the patient's state over the series of hospital visits, which can be correlated to changes in the patient's health over the series of hospital visits.

In step 325 each combination of data entries is grouped (e.g., sorted) according to the second criteria. For example, the data entries can be sorted in accordance with a second criteria, which can be a feature of the data that does not change. Selecting criteria that remains unchanged allows the data to be grouped together by selecting different parameters to discover if and how data relate to each other, and identify relationships that exist between data. For example, this second criteria could be a factor such as patient ID, date of birth, ethnicity, or gender. These factors can be used to group multiple patients' data by age group, gender, ethnicity, etc. By selecting the date of birth as a factor, the age of a patient is then known.

In step 325, the second criteria could allow the data to be sorted by age or a range of ages. Thus, all of the patients' data would be listed from the youngest patient to the oldest patient. This step 325 would then allow the user to see whether trends exist in the data that correlate to the age of the patient, i.e. age-related changes that correspond to health. For example, the execution of step 325 could yield data that the user could read and discover an increase in the incidence of, e.g., heart-related issues as patient age increases. From this step 325, the user could then determine that as patients get older, there is a higher likelihood of being a heart patient (e.g. age-related heart failure). The result, as shown in step 330, each combination of data entries is classified. For example, a body of data associated with a given patient is sorted to prioritize a combination based on a classification of data based on the applied criteria and associated rules. The data is then represented in a human readable format in step 335 such that the user can validate or modify treatment based on the outcome. Accordingly, a prioritized list of the assigned and sorted data entries is presented to a user to facilitate decision support.

FIG. 4 is a flowchart showing a process of transforming an initial data entry through a series of sorting algorithms to obtain a sorted data set that can then be analyzed using a variety of statistical and analytical methods. For example, in step 400 a user accesses a database containing a list of objects (e.g. a patient, restaurant, store, or delivery truck) and a corresponding list of events (e.g. hospital visit, customer order, merchandise receipt, or package delivery) for each object in the list. For each event that occurs, in step 405, a state is assigned to the object. As one example, for a patient receiving care, a starting status is assigned to the patient (e.g. ready for diagnosis, in treatment, or in recovery). As another example, a user (e.g., a care provider) accesses a database containing data associated with the patients visiting a particular hospital. Either automatically by use of a series of rules, or by manipulating data though a graphical user interface (GUI), in step 410 a starting state is assigned for each data entry, e.g., “level of health” for each of those patients. As described herein, a state can be a patient condition, such as a recorded physiological condition, or can be a quantifiable event associated to the patient, such as number of visits to a treatment facility.

To illustrate how data assignment can work in a healthcare setting, consider the following example: a diabetic patient goes to a hospital for a first visit. During this visit, in step 415, the provider assesses the patient and identifies a level of sickness for this patient on a scale from one to ten. The level of sickness can be assigned based on a variety of factors, including but not limited to: the location of the patient visit (the emergency room, urgent care, or the physician's office); whether the patient was admitted to the hospital, and if so how long was the stay; and whether any tests or procedures were identified to aid in a diagnosis. At the end of the patient's visit, in step 420 the patient is assigned a status (state 1) by the doctor, which is noted in the medical record. On a second visit to the hospital, such as a follow-up visit, the data collected from a variety of sources validates that the patient is feeling better, and in step 425 the doctor assigns a second, different status (state 2) to the patient visit after determining a second level of sickness correlating to the patient's current condition. On a third visit, the data collected from one or more sources may indicate that the health of the same patient has deteriorated resulting in another visit to the hospital, e.g., a third visit. As before, in step 430 the doctor assesses the patient's health condition based on the collected data and determines a level of sickness, noted as yet another, independent status (state 3) and in step 435 is stored in an associated medical record. For any visits thereafter, each visit would also be assigned a state. Based on the states assigned to each data entry, the level of sickness assigned to each visit, whether the same or different, in step 440 that state is identified as a unique state base on the timing of the visit, for example. Thus, a prioritized list can be presented (e.g., displayed) which characterizes the information in accordance with the particular set of data subject to the particular sorting requirement.

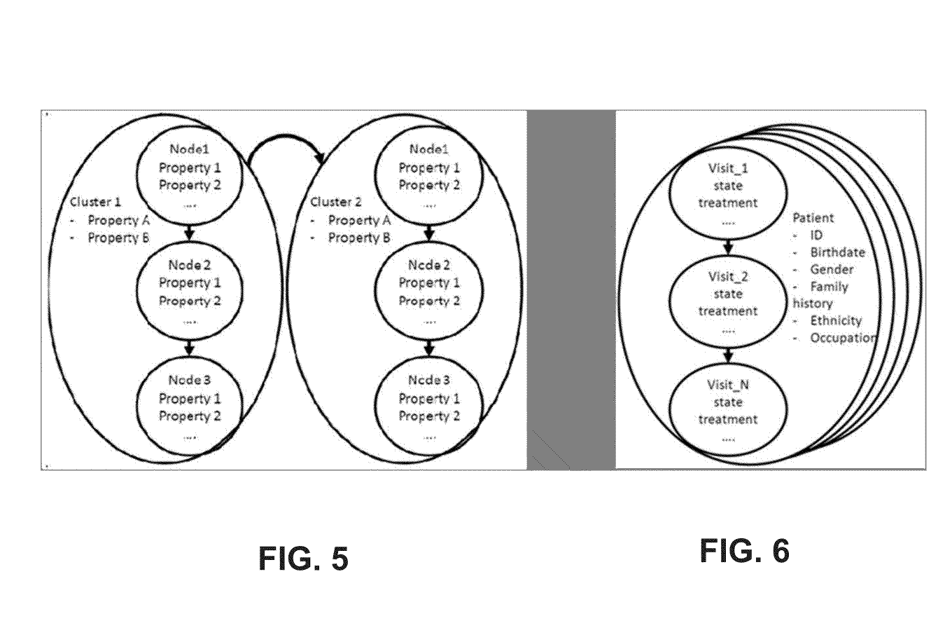

FIGS. 5 and 6 provide examples of a body of data (e.g., cluster) with qualities and properties of a data entry workflow, as described herein. FIG. 5 depicts a general example of a data sorting system product, showing two clusters having two sets of properties criteria. A specific example of the invention related to healthcare can be seen in FIG. 6. The data sorting system classifies each entry according to a property (e.g., Property 1 in FIG. 5; see also state in FIG. 6). The data sorting system sorts each property by grouping data associated with a patient in preparation for application of the sorting algorithm. Each property can represent one or more data entries, such as through collection from a data source (e.g., data source 204 or database 203 of FIG. 2). An example database could represent a patient's medical history (e.g., Visit_1, Visit_2, Visit_n in FIG. 6; see also Node 1, Node 2, Node 3 in FIG. 5).

The data sorting system thus determines any change in the patient data according to a first set of property criteria (e.g., Property 1 in FIG. 5; see also treatment in FIG. 6). The data sorting system compares each data entry and sorts the various data entries by grouping data entries based on a second criteria (e.g., Property A of FIG. 5; see also Patient ID of FIG. 6). The data sorting system assigns tags (e.g., an identifier) based on properties of the unstructured data to tag each entry with one or more additional factors that facilitates the transformation of large unstructured data into prioritized data sets.

It will be appreciated that any module or component described that executes instructions or operations may include or otherwise have access to computer readable media such as memory storage, computer storage, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or the PC, the mobile device, the tablet, and the laptop or accessible or connectable thereto. Any application or module herein described may be implemented using computer readable/executable instructions or operations that may be stored or otherwise held by such computer readable media.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the claims.

Having described the invention, the following is claimed:

1. A method for sorting a plurality of data records, comprising:
collecting a plurality of data entries from a data record of the plurality of data records;
assigning each data entry of the plurality of data entries with a unique entry ID;
identifying an initial state of a given data entry of the plurality of data entries;
assigning a given state to the given data entry;
determining a change in state of the given data entry from the initial state to the given state;
sorting the given data entry according to a first criteria;
sorting the given data entry according to a second criteria, wherein the sorting comprises assigning a score to the given data entry;
prioritizing the given data entry based on the score assigned to the given data entry respective of a score assigned to each remaining data entry of the plurality of data entries; and
generating an output representing a prioritized list of the plurality of data entries based on a respective score that can be displayed in a display.

2. The method of claim 1, wherein each data entry is associated with a patient condition or event, wherein each data entry is assigned an initial state.

3. The method of claim 1, wherein the initial state of each of the data entries from each of the plurality of data records is different.
